(19) United States
(12) Patent Application Publication
(10) Pub. No.: US 2022/0350734 A1
(43) Pub. Date: Nov. 3, 2022

(54) APPLICATIONS THAT INCLUDE EXECUTION LOCATION MARKERS AND AN AWARENESS BUILDER ENGINE

(71) Applicant: Hewlett-Packard Development Company, L.P., Spring, TX (US)

(72) Inventors: Mauricio Coutinho Moraes, Porto Alegre (BR); Daniele Antunes Pinheiro, Porto Alegre (BR); Jhonny Marcos Acordi Mertz, Porto Alegre (BR)

(73) Assignee: Hewlett-Packard Development Company, L.P., Spring, TX (US)

(21) Appl. No.: 17/608,767

(22) PCT Filed: Sep. 12, 2019
(86) PCT No.: PCT/US2019/050736

§ 371 Date: Nov. 4, 2021

(51) Int. Cl. G06F 11/36; G06F 11/34; G06F 11/30

(52) U.S. Cl. CPC G06F 11/3692; G06F 11/3466; G06F 11/302

(57) ABSTRACT

An example system includes: an application comprising code segments and execution location markers which return indicators identifying behavior of the code segments in response to receiving a request to process the application. The example system includes an application manager engine to receive the request and pass the request to the application. The example system includes the application manager engine including an awareness builder engine to: receive from the application, a response to the request that includes the indicators identifying the behavior of the code segments; store the indicators local to the application manager engine; and transmit the response.

### BACKGROUND

Identification of behavior of an application, for example an application that corresponds to a website, may occur by running the application offline, for example by testing the application under certain conditions.

### BRIEF DESCRIPTION OF THE DRAWINGS

Reference will now be made, by way of example only, to the accompanying drawings in which:

FIG. 1 is a block diagram of an example system to implement applications that include execution location markers and an awareness builder engine.

FIG. 2 a block diagram of another example system to implement applications that include execution location markers and an awareness builder engine.

FIG. 3 is a flow diagram of an example method to implement applications that include execution location markers and an awareness builder engine.

FIG. 4 is a block diagram of an example computer-readable medium including instructions that causes a processor to implement applications that include execution location markers and an awareness builder engine.

FIG. 5 is an example of code segments and execution location markers.

FIG. 6 is an example of the system of FIG. 2 storing indicators identifying behavior of code segments in response to receiving a request to process an application.

FIG. 7 is an example of the system of FIG. 2 storing indicators identifying behavior of code segments in response to receiving a request to process an application.

### DETAILED DESCRIPTION

Identification of behavior of an application, for example an application that corresponds to a website, may occur by running the application offline, for example by testing the application under certain conditions. However, such an approach may be inefficient and may not represent behavior of the application in real-time.

However, as described herein, an application may be made “self-aware” by providing the application with execution location markers which return indicators identifying behavior of the application and/or or code segments, of the application. For example, the execution location markers may return time stamps, and execution location markers before and after code segments in the application such that time stamps from pairs of execution location markers may indicate an execution time for the code segments therebetween. However, not receiving an indicator for an execution location marker after a code segment that is “supposed” to run may indicate a failure of the code segment (e.g. as the execution location marker following a code segment has not executed due to failure of the code segment).

However, an application may be made self-aware in any suitable manner and/or the execution location markers may return any suitable information which indicates how the application is behaving at a run-time. Hence, such self-aware applications may dynamically monitor and analyze themselves and/or autonomously change their behavior based on the information returned by the execution location markers.

Hence, provided herein is a system comprising: an application engine comprising code segments and execution location markers which return indicators identifying behavior of the code segments in response to receiving a request to process the application engine; and an application manager engine to receive the request and pass the request to the application engine, the application manager engine including an awareness builder engine to: receive from the application engine, a response to the request that includes the indicators identifying the behavior of the code segments; store the indicators local to the application manager engine; and transmit the response.

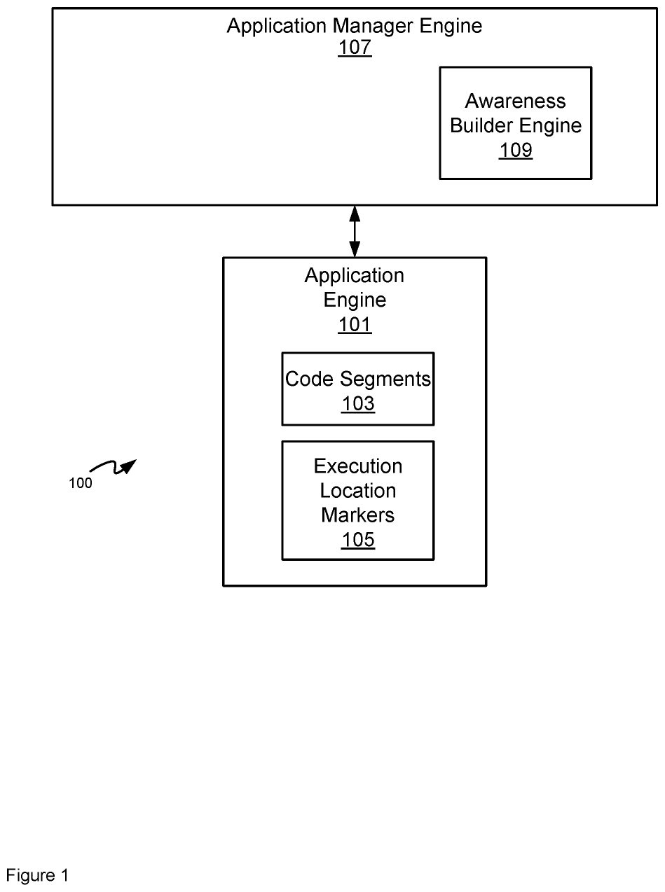

FIG. 1 is a block diagram of an example system 100 to implement applications that include code segments and execution location markers and an awareness builder engine. The system 100 may include an application engine 101 comprising code segments 103 and execution location markers 105, and an application manager engine 107 that includes an awareness builder engine 109.

As will be described in more detail below, the code segments 103 may comprise portions and/or segments of code and/or source code and/or executable instructions, and the like, of an application executed when the application engine 101 is implemented, and the like.

As will be described in more detail below, the execution location markers 105 may generally comprise functions and/or engines and/or executable instructions, and the like, which return indicators identifying behavior of the code segments 103; while the execution location markers 105 will be described in more detail below, in some examples the indicators returned by the execution location markers 105 may comprise: a line number of an application executed when the application engine 101 is implemented, and the like, at which an execution location marker 105 is located.

As used herein, the term “engine” refers to hardware (e.g., a processor, such as a central processing unit (CPU) an integrated circuit or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or implemented or interpreted by a processor), or hardware and software hosted at hardware.

For example, the application engine 101 may comprise hardware or a combination of software and hardware for implementing an application, such as a website, and the like. In some examples, the application engine 101 may comprise a portion of a server which hosts the application and/or the website. However, the application engine 101 may comprise hardware or a combination of software and hardware which correspond to any suitable application.

The application engine 101 comprises the code segments 103 and the execution location markers 105. The execution location markers 105 return indicators identifying behavior of the code segments 103 in response to receiving a request to process the application engine 101.

It is understood that processing the application engine 101 may include controlling the hardware and/or software of the application engine 101 to implement and/or process an application and/or executable instructions of the application engine 101.

For example, a request may be received via a communications network and the like, for example from a requesting device and/or a client device, and the like. The request may be to implement and/or process the application engine 101 (and/or an application thereof). The request may comprise a HyperText Transfer Protocol (HTTP) request transmitted to a server implementing the application engine 101, for example to implement a website.

The application engine 101 receives the request and may responsively implement the code segments 103 and the execution location markers 105. The execution location markers 105 may return indicators identifying behavior of the code segments 103 during the execution, for example at a run-time of the application engine 101 and/or in real-time. In particular, the indicators indicate behavior of the application engine 101 and/or the code segments 103 at a run-time and/or in real-time. However, the application engine 101 may also be implemented in test-mode, for example under specified “normal” and/or “ideal” conditions, and the indicators may indicate behavior of the application engine 101 and/or the code segments 103 in the test-mode, for example to identify “expected” behavior of the application engine 101.

Such a request is generally received via the application manager engine 107 which may comprise an application programming interface (API) of the application engine 101. Put another way, the application manager engine 107 may generally receive the request and pass the request to the application engine 101.

The application engine 101 may generate a response to the request that includes the indicators identifying the behavior of the code segments 103.

The application manager engine 107 includes the awareness builder engine 109. The awareness builder engine 109 generally: receives from the application engine 101, the response to the request, the response including the indicators identifying the behavior of the code segments 103, the indicators returned by the execution location markers 105.

In some examples, the indicators may be included in a header of the response as received from the application engine 101. For example, the request may comprise an HTTP request, and the response may comprise an HTTP response, with the indicators in an HTTP header thereof. However, the indicators may be included in the response in any suitable manner.

The awareness builder engine 109 stores the indicators local to the application manager engine 107, and transmits the response, for example back to the requesting device.

The indicators may be stored at a database, and the like, maintained by the application manager engine, and/or in any other suitable memory and/or memory structure local to the application manager engine 107.

In some examples, the awareness builder engine 109 may remove the indicators from the response prior to transmitting the response. In other examples, the awareness builder engine 109 may not remove the indicators, and the response may be transmitted with the indicators; in these examples, the requesting device may receive the indicators, and may optionally process the indicators.

The indicators may comprise any suitable indication of behavior of the application engine 101 and/or the code segments 103. In some examples, the indicators may include location indications of respective execution location markers associated with respective code segments 103. For example, such location indications may indicate a line number of a code segment 103 within the application engine 101; in such examples, the location indications may indicate that a code segment 103 which preceded an associated execution location marker 105 was executed.

In yet further examples, the indicators may comprise a time stamp of an execution location marker, such as a relative or absolute time that an execution location marker was executed. In some of these examples, execution location markers 105 may precede and follow a code segment 103 and hence the indicators may comprise a pair of time stamps which indicate a time for executing a code segment 103 between two associated execution location markers 105.

However, in some examples, the indicators may include an indication of the request and/or the response may include an indication of the request; in these examples, the awareness builder engine 109 may be further to store the indication of the request with the indicators and/or store the indication of the request with the indicators and/or in a field of the indicators. Such an indication of the request may comprise a portion of the request, and is described in more detail below.

In some examples, the indicators may include data returned by the code segments 103, which may indicate valid data and/or invalid data. In other words, a code segment 103 may be to return one (or more than one) of a plurality of data types, some of which may be defined as valid, whereas other data types may be defined as invalid.

However, the indicators may indicate any suitable behavior of the application engine 101 and/or the code segments 103. For example, such behavior may include, but is not limited to the following:

performance of the application engine 101 and/or the code segments 103, such as elapsed execution delay, CPU processing time, and the like. Such performance may be indicated by time stamps and/or location indicators of the execution location markers 105, as described above.

authentication/authorization of the application engine 101 and/or the code segments 103. Such authentication and/or authorization may be indicated by a combination of a portion of the request (which may include identifiers of a requesting device and/or passwords, and/or other data etc. used to access certain code segments 103) and the time stamps and/or location indicators of the execution location markers 105. Such behavior may indicate permissions to certain code segments 103 that were granted and/or operations that occurred due to data received with the request.

expected/known and/or unexpected/unknown behaviors of the application engine 101 and/or the code segments 103. For example, “expected” and/or “known” behaviors may include behaviors that occur during “normal” operation of the application engine 101 that may be determined during functional testing of the application engine 101. Conversely, “unexpected” and/or “unknown” behaviors may include behaviors that occur during “abnormal” operation of the application engine 101 and/or which do not occur during functional testing of the application engine 101. In a particular example, an expected/known behavior may be the execution of code segments 103 that makes use of an instance of a working relational database service (RDS, which may include, but is not limited to, an Amazon Web Services (AWS) RDS); an unexpected behavior may be the same code segments 103 that makes use of a not working (e.g., failed) AWS RDS instance. In some examples, the awareness builder engine 109 may be configured to detect and/or log (e.g. local to the application manager engine 107) expected and/or unexpected behavior using the indicators, for example during functional testing. In particular, the awareness builder engine 109 may be to: determine when the application engine 101 is being implemented during functional testing, and store the resulting received indicators in association with an indication of expected behavior.

monitoring/profiling of the request and/or resulting behavior of the application engine 101 and/or the code segments 103. For example, the request may include an HTTP request and the indicators may include the HTTP request and/or a portion of the request (e.g., a method (e.g. a command) and/or a path and/or parameters and/or headers and/or a payload, and the like), and the indicators may further indicate behavior of the application engine 101 and/or the code segments 103 that resulted from the HTTP request. Hence, request, and/or HTTP request, characterization and/or typification may occur, and/or a determination of which parts of the request and/or the HTTP request were implemented may occur.

monitoring/profiling of the response and/or associated behavior of the application engine 101 and/or the code segments 103. For example, the response returned by the application engine 101 may include an HTTP request and the indicators may include the HTTP request and/or a portion of the request (e.g., headers and/or payloads and/or status codes, and the like), and the indicators may further indicate behavior of the application engine 101 and/or the code segments 103 that resulted in the HTTP response. Hence, response, and/or HTTP response, characterization and/or typification may occur, and/or a determination of which code segments 103 were implemented that resulted in the response and/or the HTTP response.

temporal/contextual characterization of application-specific relevant events. For example the indicators may include absolute and/or relative timestamps, which may be grouped and/or queried according to given time-windows.

In general, the indicators stored locally to the application manager engine 107 may be queried, for example from a testing device, to determine behavior of the application engine 101. While such queries may be handled in any suitable manner, in some examples, the application manager engine 107 may be adapted to include an awareness engine, and the like, to handle such queries.

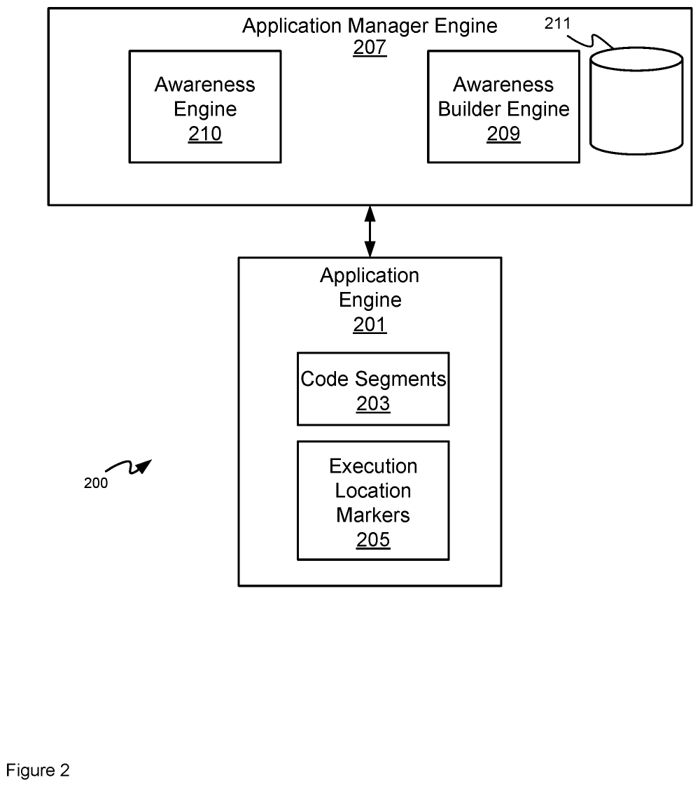

For example, attention is next directed to FIG. 2 which is a block diagram of another example system 200 to implement applications that include code segments and execution location markers and an awareness builder engine. The system 200 is substantially similar to the system 100, with like components having like numbers, but in a “200” series rather than a “100” series. For example, the system 200 may include an application engine 201 comprising code segments 203 and execution location markers 205, and an application manager engine 207 that includes an awareness builder engine 209; the application engine 201 the code segments 203, the execution location markers 205, the application manager engine 207 and the awareness builder engine 209 are respectively similar to the application engine 101 the code segments 103, the execution location markers 105, the application manager engine 107 and the awareness builder engine 109, as described above.

However, in contrast to the system 100, in the system 200, the application manager engine 207 includes an awareness engine 210 and a memory 211.

In general, the awareness builder engine 209, the awareness engine 210 and the memory 211 may be components of the application manager engine 207, such as an API for the application engine 201. In some examples, the memory 211 may be a component of the awareness builder engine 209.

The awareness engine 210 may be to: receive a query for behavior of the application engine 201, the query including criteria for searching the indicators stored locally to the application manager engine 207, as described above; retrieve, from the indicators stored locally to the application manager engine 207, data corresponding to the criteria of the query; and return a response to the query, the response including the data retrieved and/or the response derived from the data as retrieved.

The memory 211 may include a database and the like, which is local to the application manager engine 207. The memory 211 may store the indicators received with a response from the application engine 201. In particular, the memory 211 may store the indicators according to a domain specific language (DSL) format and/or in any other suitable format.

The awareness engine 210 and the awareness builder engine 209 may further be to communicate with each other to process a query received at the awareness engine 210. For example, the memory 211 may be accessible via the awareness builder engine 209, for example within the application manager engine 207. When the awareness engine 210 receives a query including criteria for searching the indicators as stored, the awareness engine 210 may use the criteria to search the memory 211 (e.g. via the awareness builder engine 209), and/or the awareness engine 210 may communicate with the awareness builder engine 209 to provide the criteria to the awareness builder engine 209 to search the memory 211.

In examples where the indicators are stored at the memory 211 according to a DSL format, the query may comprise a DSL query. The query may, however, be in any suitable format.

Furthermore, the query may be for any suitable information as defined by the criteria. For example, the criteria for searching indicators stored locally to the application manager engine 207 may comprise a criterion indicative of a time period in which the application engine 201 was implemented. Indicators which include time stamps within the time period may be returned in a response to the query. In another example, the criteria may comprise an identifier associated with the request; for example an identifier of a requesting device, and the like (e.g. and/or an identifier of a company and/or user associated with a requesting device and/or any other type of identifier which may be included in a request and/or an HTTP request).

Other examples of queries may include:

queries for execution delay times between locations in the application engine 201, which may include specific code segments 203. Such queries may include criteria indicating line numbers of the application engine 201, such as a start line number and a stop line number, such that indications that include location indicators between the start line number and the stop line number may be returned. Such queries may further include a time period in which the application engine 201 was implemented (and/or may have been implemented) and/or a given number of executions of the application engine 201 (e.g. the last 1000 executions, and the like). Such queries may include further criteria; for example a length of time that the specific code segments 203 took to implement (e.g. implementations of the code segments 203 between the start line number and the stop line number that took longer than 1 second to implement, and/or executions of the code segments 203 between the start line number and the stop line number that took less than 1 second to implement). However, the queries may include any suitable criteria.

-queries based on information in a request. For example the query may include an identifier of a requesting device and/or an identifier of a company and/or user associated with a requesting device; it is understood that such identifiers may be in a request and/or an HTTP request (e.g. in a header thereof). Hence, a query may be for data indicative of executions of the application engine 201 that occurred in response to requests that include specific identifiers. Such queries may further include other criteria, such as the aforementioned line numbers and/or time periods, and/or any other suitable criteria. For example, such queries may be for executions of the application engine 201 where valid data was returned for code segments 203, and/or for executions of the application engine 201 where invalid data was returned for code segments 203. Such valid and/or invalid data may be defined in a query (e.g. the query may be for executions of specific code segments 203 that returned specific data and/or types of data).

In other examples, queries based on information in a request may include queries for data indicative of executions of the application engine 201 that occurred in response to requests that include a specific method s(e.g. a specific command) and/or a specific path and/or specific parameters and/or specific headers and/or specific payloads, and the like. For example, a query may for indications that resulted when the application engine 201 was implemented in response to a request that includes a specific header and/or a method (e.g. a “PUT” request). Such queries may also include any of the other criteria described heretofore.

queries based on information in a response. Examples of information in a response are described above, and such queries may be for any such information. Such queries may also include any of the other criteria described heretofore.

queries for expected/known behavior and/or unexpected/unknown behavior. For example, a query maybe for indicators which match and/or align with and/or are similar to indicators stored in association with an identifier of expected behavior; and/or a query maybe for indicators which do not match and/or do not align with and/or are not similar to indicators stored in association with an identifier of expected behavior.

Indeed, any other suitable queries and/or combination of criteria are within the scope of the present specification.

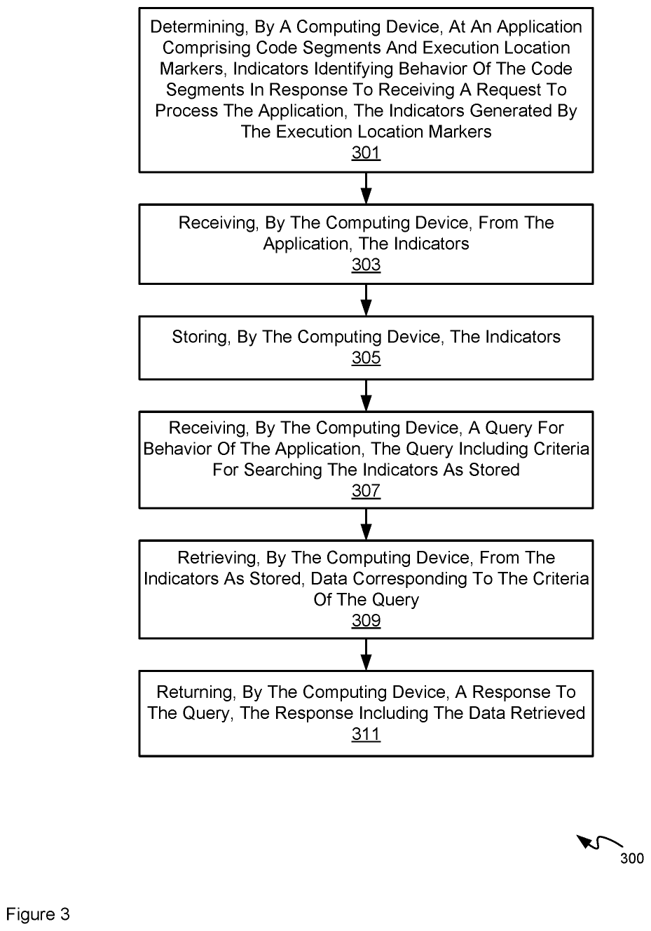

Referring to FIG. 3, a flowchart of an example method 300 to implement a method to implement applications that include execution location markers and an awareness builder engine is depicted. In order to assist in the explanation of method 300, it will be assumed that method 300 may be performed with the system 200, and at least partially by a computing device implementing the system 200 and/or a processor thereof. Indeed, the method 300 may be one way in which the system 200 may be configured. Furthermore, the following discussion of method 300 may lead to a further understanding of the system 200, and its various components. Furthermore, it is to be emphasized, that method 300 may not be performed in the exact sequence as shown, and various blocks may be performed in parallel rather than in sequence, or in a different sequence altogether. Furthermore, it is to be emphasized that the method 300 may alternatively be performed with the system 100, and at least partially by a computing device implementing the system 100 and/or a processor thereof.

Beginning at a block 301, a computing device determines at an application comprising code segments and execution location markers, indicators identifying behavior of the code segments in response to receiving a request to process the application, the indicators generated by the execution location markers. In particular, the application may be implemented by the application engine 201 and the code segments and execution location markers may be implemented, respectively, as the code segments 203 and the execution location markers 205.

At a block 303, the computing device receives, from the application, the indicators, for example with a response to the request received at the block 301. The indicators may be received at the awareness builder engine 209, as described above. As previously described, the indicators identifying behavior of the code segments may comprise timestamps associated with execution of a respective code segment 203 and/or any other suitable indicator. Various other examples of the indicators are described above, and any suitable indicator is within the scope of the present specification.

At a block 305, the computing device stores the indicators. For example, the indicators may be stored at the memory 211 using the awareness builder engine 209. As also described above, a portion of the request received at the block 301 may be stored in association with the indicators and/or the indicators may include a portion of the request received at the block 301. As also described above, a portion of a response with which the indicators may be received may be stored in association with the indicators and/or the indicators may include a portion of the response.

At a block 307, the computing device receives a query for behavior of the application, the query including criteria for searching the indicators as stored. The query may be received at the awareness engine 210. The criteria for searching the memory storing the indicators may comprise a criterion indicative of a time period in which the application was executed. Various other examples of the criteria are described above including, but not limited to, information associated with the request received at the block 301 and/or the response.

At a block 309, the computing device retrieves from, the indicators as stored, data corresponding to the criteria of the query. The data corresponding to the criteria of the query may be retrieved from the memory 211 by the awareness engine 210 communicating with the awareness builder module 209.

At a block 311, the computing device returns a response to the query, the response including the data retrieved. The awareness engine 210 may build and/or generate the response, and return the response.

In yet further examples, the computing device may return a response to the query, the response derived from the data as retrieved. For example, the response may not explicitly include the data retrieved. Rather the awareness engine 210 and/or the awareness builder module 209 may derive “conclusions” based on the data retrieved; for example, the awareness engine 210 and/or the awareness builder module 209 may process the data to indicate, for example, a number of indications that correspond to a query. Hence, for example, when a query is for the indicators that occurred between in a given time period between a pair of execution location markers 205, rather than return the indicators, the awareness engine 210 and/or the awareness builder module 209 may count the number of indicators that met the criteria of the query and return the number.

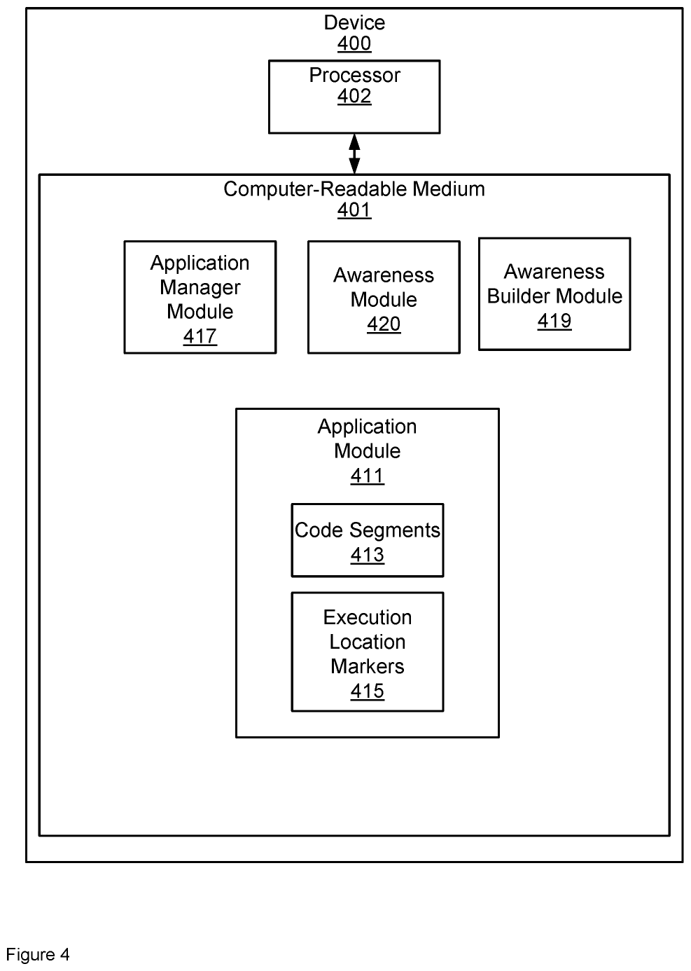

FIG. 4 is a block diagram of an example device 400 that includes a computer-readable medium 401 and a processor 402. The computer-readable medium 401 includes instructions that, when implemented by the processor 402, cause the processor 402 to implement applications that include execution location markers and an awareness builder engine. The computer-readable medium 401 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 402 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc. The computer-readable medium 401 or the processor 402 may be distributed among a plurality of computer-readable media or a plurality of processors.

The computer-readable medium 401 includes modules. As used herein, a “module” (in some examples referred to as a “software module”) is a set of instructions that when executed or interpreted by a processor or stored at a processor-readable medium realizes a component or performs a method.

The computer-readable medium 401 may include an application module 411 comprising code segments 413 and execution location markers 415 which return indicators identifying behavior of the code segments 413 in response to receiving a request to process the application module 411. The application module 411 may include instructions that, when executed, cause the processor 402 to return indicators identifying behavior of the code segments 413 in response to receiving a request to process the application module 411.

The computer-readable medium 401 may include an application manager module 417. The application manager module 417 may include instructions that, when executed, cause the processor 402 to receive the request and pass the request to the application module 411.

The computer-readable medium 401 may include an awareness builder module 419. The awareness builder module 419 may include instructions that, when executed, cause the processor 402 to: receive from the application module 411, a response to the request that includes the indicators identifying the behavior of the code segments 413; store the indicators local to the application manager module 417; and transmit the response.

The computer-readable medium 401 may include an awareness module 420. The awareness module 420 may include instructions that, when executed, cause the processor 402 to: receive a query for behavior of the application module 411, the query including criteria for searching the indicators as stored; retrieve, via the awareness builder module 419, from the indicators as stored, data corresponding to the criteria of the query; and return, at the processor 402, a response to the query, the response derived from the data as retrieved.

Alternatively, the response may include the data as retrieved.

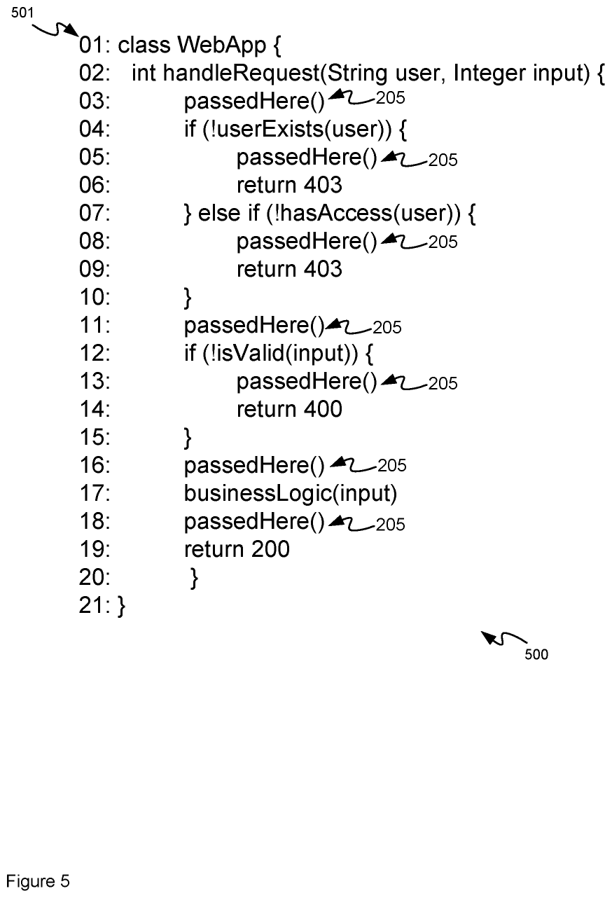

An example of code segments 203 and execution locations markers 205 are next described with respect to FIG. 5. In particular, FIG. 5 depicts a code snippet 500 in Java-like code. Various functions, and other parts of the code snippet 500, are on various lines indicated by line numbering 501. The code snippet 500 may be an example of code segments 203 and execution locations markers 205 of the application engine 101, the application engine 201 and/or the application module 411. While execution locations markers 205 are depicted in specific locations in the code snippet 500, the execution locations markers 205 may be located in any suitable location, and may be added manually and/or automatically.

The code snippet 500 generally performs an authorization of a user based on a string “user” received, along with an integer “input”, for example in a request to process the code snippet 500 (e.g. a request to process the application engine 101, the application engine 201 and/or the application module 411).

The code snippet 500 performs an authorization of the “user” for example by determining whether the “user” exists, for example in a database, and the like (e.g. via a function “!userExists(user)”), and if the “user” exists, whether the “user” has access (e.g. via a function “!hasAccess(user)”), for example to implement a function “business logic(input)”. Each of the depicted functions may correspond to a code segment 203.

As depicted, the code snippet 500 further comprises execution location markers 205, for example a function “passedHere( )” which may call a function which may return indicators identifying the behavior of the code segments such as a line number being executed and/or a time stamp and/or a portion of the request, and/or any other suitable information, as described above. Regardless, when a given instance of the function “passedHere( )” is called, the indicators returned indicate that a code segment 203 which precedes the given instance of the function “passedHere( )” was executed; conversely, when a given instance of the function “passedHere( )” is not called, a code segment 203 which precedes the given instance of the function “passedHere( )” was not executed, for example due to a failure of the code segment 203.

A code segment 203 may be between given pairs of the function “passedHere( )” (and/or pairs of execution location markers 205), and the indicators returned may indicate further behavior of the code segment 203 therebetween, such as an execution time of the code segment 203.

Regardless, the indicators returned by the function “passedHere( )” are stored by the awareness builder engine 209 and/or the awareness builder module 419.

The line numbers 501 of the execution location markers 205 may be used to define given behaviors of the code snippet 500, which may correspondingly be used as criteria in queries to the awareness engine 210 and/or the awareness module 420. For example, with reference to the line numbers 501, such a query may include the line numbers “3” and “5” at which are two execution location markers 205, between which is the code snippet “!userExists(user)”. Hence, when the indicators generated the functions “passedHere( )” at line numbers “3” and “5” are retrieved, the behavior of the code snippet “!userExists(user)” may be determined.

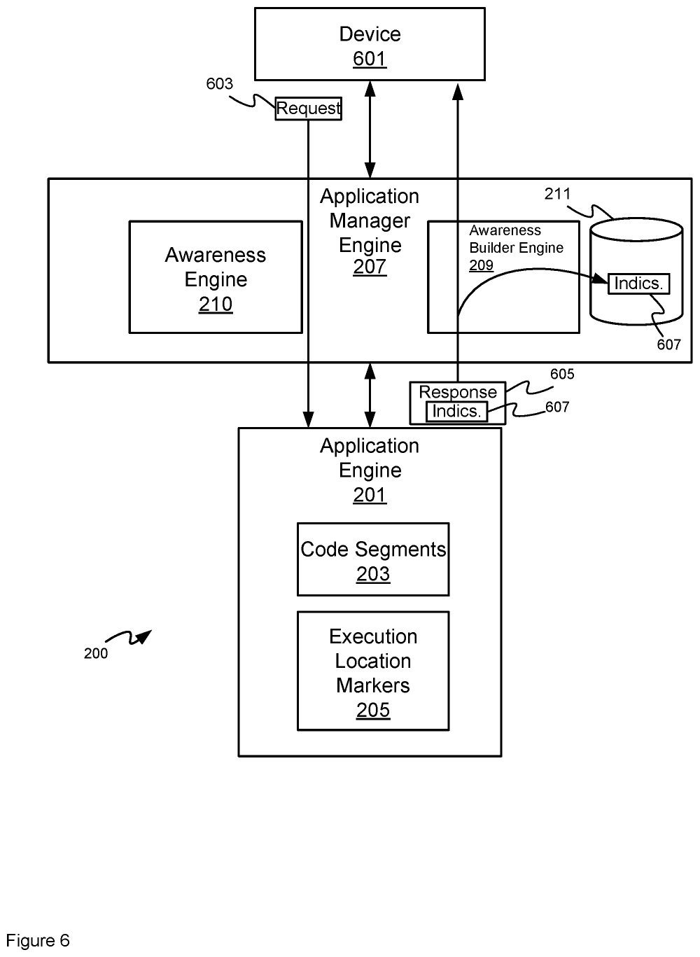

Attention is next directed to FIG. 6 which depicts the system 200 storing indicators identifying behavior of code segments in response to receiving a request to process an application.

For example, in FIG. 6, the system 200 is depicted with a device 601 in communication with the application engine 201 via the application manager engine 207, for example using a communication network and the like. The device 601 transmits a request 603 to the application engine 201 via the application manager engine 207, the request 603 to implement the application engine 201. For example, the request 603 may be generated at a browser application at the device 601, and the request 603 may be for a website implemented via the application engine 201.

The application engine 201 returns a response 605 which includes indicators 607 generated by the execution location markers 205. The response 605 is received at the awareness builder engine 209, which stores the indicators 607 at the memory 211. The response 605 is transmitted to the device 601 (e.g. with, or without, the indicators 607).

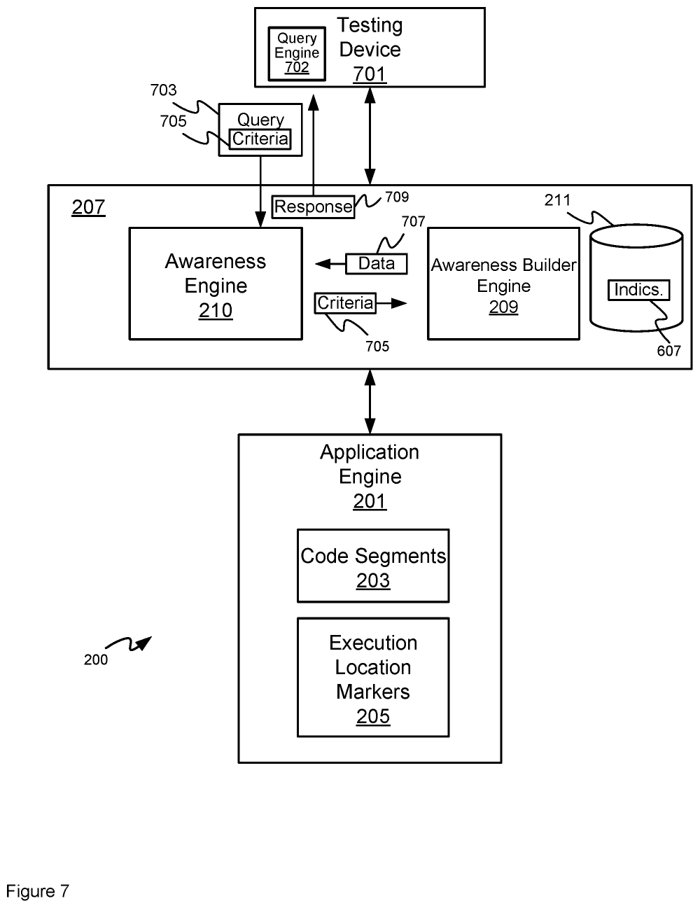

Attention is next directed to FIG. 7 which depicts the system 200 with the indicators 607 stored at the memory 211, and with a testing device 701 in communication with the awareness engine 210. For example, as depicted, the testing device 701 includes a query engine 702 to generate queries to the awareness engine 210. As depicted, the testing device 701 is transmitting a query 703 to the awareness engine 210 which includes criteria 705 for searching the stored indicators 607. The awareness engine 210 communicates with the awareness builder engine 209 to search the stored indicators 607 using the criteria 705 to generate data 707 corresponding to the criteria 705. The awareness engine 210 transmits a response 709 to the testing device 701 in response to the query 703 based on the data 707.

In any event, provided herein are devices, system and methods for implementing applications that include execution location markers and an awareness builder engine.

It should be recognized that features and aspects of the various examples provided above may be combined into further examples that also fall within the scope of the present disclosure.

1. A system comprising:
an application comprising code segments and execution location markers which return indicators identifying behavior of the code segments in response to receiving a request to process the application; and
an application manager engine to receive the request and pass the request to the application,
the application manager engine including an awareness builder engine to: receive from the application, a response to the request that includes the indicators identifying the behavior of the code segments; store the indicators local to the application manager engine; and transmit the response.

2. The system of claim 1, wherein the indicators are included in a header of the response as received from the application.

3. The system of claim 1, wherein the indicators include location indications of respective execution location markers associated with respective code segments.

4. The system of claim 1, wherein the application manager engine comprises an application programming interface of the application.

5. The system of claim 1, wherein the response includes an indication of the request, and the awareness builder engine is further to store the indication of the request with the indicators.

6. A method comprising:
determining, by a computing device, at an application comprising code segments and execution location markers, indicators identifying behavior of the code segments in response to receiving a request to process the application, the indicators generated by the execution location markers;
receiving, by the computing device, from the application, the indicators;
storing, by the computing device, the indicators;
receiving, by the computing device, a query for behavior of the application, the query including criteria for searching the indicators as stored;
retrieving, by the computing device, from the indicators as stored, data corresponding to the criteria of the query; and
returning, by the computing device, a response to the query, the response including the data retrieved.

7. The method of claim 6, further comprising storing, by the computing device, a portion of the request in association with the indicators.

8. The method of claim 6, wherein the indicators identifying behavior of the code segments comprise timestamps associated with execution of a respective code segment.

9. The method of claim 6, wherein the criteria for searching the indicators as stored comprises a criterion indicative of a time period in which the application was executed.

10. The method of claim 6, wherein the criteria for searching the indicators as stored comprises information associated with the request.

11. A non-transitory computer-readable medium comprising instructions that, when executed by a processor, cause the processor to:
execute an application module comprising code segments and execution location markers which return indicators identifying behavior of the code segments in response to receiving a request to process the application module;
execute an application manager module to receive the request and pass the request to the application module;
execute an awareness builder module to: receive from the application module, a response to the request that includes the indicators identifying the behavior of the code segments; store the indicators local to the application manager module; and transmit the response; and
execute an awareness module to: receive a query for behavior of the application module, the query including criteria for searching the indicators as stored; retrieve, via the awareness builder module, from the indicators as stored, data corresponding to the criteria of the query; and return, at the processor, a response to the query, the response derived from the data as retrieved.

12. The non-transitory computer-readable medium of claim 11, wherein application manager module comprises an application programming interface (API) of the application module, the API comprising the awareness building module and the awareness module.

13. The non-transitory computer-readable medium of claim 11, wherein the indicators are stored according to a domain specific language (DSL) format.

14. The non-transitory computer-readable medium of claim 11, wherein the query comprises a domain specific language (DSL) query.

15. The non-transitory computer-readable medium of claim 11, wherein the awareness module and the awareness builder module are further to communicate with each other to process the query.
